(19) United States
(12) Patent Application Publication
(10) Pub. No.: US 2011/0171321 A1
(43) Pub. Date: Jul. 14, 2011

(54) ELASTOMERIC ARTICLE HAVING A BROAD SPECTRUM ANTIMICROBIAL AGENT AND METHOD OF MAKING

(76) Inventors: Benjamin P. Luchsinger, Bozeman, MT (US); Todd R. Meyer, Bozeman, MT (US)

(21) Appl. No.: 13/062,918

(22) PCT Filed: Sep. 11, 2009
(86) PCT No.: PCT/US2009/005103

§ 371 Date: Mar. 8, 2011

Related U.S. Application Data
(60) Provisional application No. 61/191,730, filed on Sep. 11, 2008.

(51) Int. Cl. A01N 59/16; A01P 1/00

(52) U.S. Cl. 424/618

(57) ABSTRACT

A method for impregnating a polymer with a bioactive material includes preparing a bioactive metal solution having a bioactive metal, a first solvent in which the bioactive metal is insoluble and a second solvent in which the bioactive metal is slightly soluble. The method also includes soaking the polymer in the bioactive metal solution. Another method for impregnating a polymer with a bioactive material includes soaking the polymer in a swelling solvent followed by soaking the polymer in a bioactive metal solution having the bioactive metal and a solvent in which the bioactive metal is slightly soluble. A bioactive metal-impregnated polymer is prepared by soaking a polymer in a saturated bioactive metal solution comprising a bioactive metal, a swelling solvent in which the bioactive metal is insoluble, and a second solvent in which the bioactive metal is slightly soluble.

### BACKGROUND

Each year in the United States there are approximately 100,000 deaths caused by nosocomial infections. A large number of these are associated with the use of medical devices, whether indwelling or having indirect contact with bodily tissues or the bloodstream (e.g., needleless connectors). An additional 1.6 million persons acquire such infections and recover, at an average cost of approximately $30,000 per episode. A common element in these episodes is the presence, attachment, and growth of microorganisms on the surface of medical devices. As organism counts on a surface increase, a biofilm is formed on the surface, made up of bacterial species that are highly resistant to commonly used antimicrobial agents and systemic antibiotics.

There are a number of ways in which the use of medical devices may increase the risk of infection. In particular, externally communicating devices provide a surface for microbial colonization and access to the interior of a patient's body. Such device-related infections are most commonly associated with devices that are implanted in and/or are in direct contact with wounds, or are connected to catheters that lead to openings in the body. Examples include but are not limited to urinary catheter drainage tubes, hemodialysis catheters, central venous catheters, and needleless connectors. Microbial contamination of such medical devices is common. If the growth of bacteria that attach to a device surface, whether a metallic or non-metallic surface, is not impeded, a biofilm is likely to form. Once a biofilm is formed, the device is permanently colonized with potentially infective microorganisms. Therefore, preventing bacterial attachment and growth on a device surface is a central strategy in preventing device related infections.

### SUMMARY

A method for impregnating a polymer with a bioactive material includes preparing a bioactive metal solution having a bioactive metal, a first solvent in which the bioactive metal is insoluble and a second solvent in which the bioactive metal is slightly soluble. The method also includes soaking the polymer in the bioactive metal solution.

An additional method for impregnating a polymer with a bioactive material includes preparing a bioactive metal solution having a bioactive metal and a solvent mixture in which the bioactive metal is slightly soluble. The method also includes soaking the polymer in the bioactive metal solution.

A further method for impregnating a polymer with a bioactive material includes soaking the polymer in a swelling solvent for between about 5 minutes and about 1 hour. The method also includes soaking the polymer in a bioactive metal solution having the bioactive metal and a solvent in which the bioactive metal is slightly soluble.

A bioactive metal-impregnated polymer is prepared by soaking a polymer in a saturated bioactive metal solution comprising a bioactive metal, a swelling solvent in which the bioactive metal is insoluble, and a second solvent in which the bioactive metal is slightly soluble.

### BRIEF DESCRIPTION OF THE DRAWINGS

FIG. 1 illustrates zone of inhibition results obtained for polyisoprene articles impregnated with silver nitrate according to one embodiment of the present invention.

FIG. 2 illustrates cumulative silver ion elution from polyisoprene treated according to one embodiment of the present invention.

FIG. 3 illustrates the quantities of silver impregnated into polyisoprene using various solvent compositions.

### DETAILED DESCRIPTION

Prior and emerging technologies are commonly focused on methods that prevent microbial colonization and/or biofilm formation by combining a device with one or more antimicrobial agents. An essential element in these technologies is that the antimicrobial agents are released from the surface of the device over time. This strategy allows for elution of antimicrobial agents from the surface of the device directly into the surrounding tissue or area. In this way, exclusive reliance on systemic treatments to control localized device related infections can be minimized or avoided. Such modification of a device is typically accomplished by incorporating an antimicrobial agent within a substrate material (in the case of a polymeric device) and/or incorporating the antimicrobial agent into a coating on the device surface. When the modified device is exposed to bodily fluids or aqueous solutions, the antimicrobial agent then elutes or leaches from the device, thereby preventing microbial colonization or biofilm formation. In addition, microorganisms in the area that are in direct contact with the device may experience significantly decreased growth rates or death.

Swelling a polymeric substrate with an appropriate solvent opens or expands pores and channels in the substrate material, allowing for uptake and deposition within these pores and channels of dissolved bioactive compounds. The chemical species that are most effectively dissolved in swelling solvents are organic compounds of low and intermediate molecular weight. These compounds are also most effectively taken up into the polymeric material. Additionally, any chemical species that dissolves in the appropriate swelling solvents are capable of being taken into the polymer.

In U.S. Pat. No. 4,917,686, Bayston describes antimicrobial properties imparted to a medical device by using a swelling agent which contains the dissolved antimicrobial agents rifampin and clindamycin. Silicone is exposed to the swelling agent for a sufficient period of time to promote swelling of the substrate, thereby allowing diffusion and migration of the antimicrobial agents into the enlarged intermolecular spaces of the substrate. The solvent is then removed so that the intermolecular spaces return to their original size and shape with the antimicrobial agent uniformly distributed for subsequent continuous migration from and diffusion through the surfaces.

In U.S. Pat. Nos. 5,624,704 and 5,902,283, Darouiche demonstrates impregnation of a non-metallic medical implant with an antimicrobial agent, comprising the steps of dissolving an effective concentration of organic-based antimicrobial agent in an organic solvent, then adding a separate penetrating agent and alkalinizing agent to the composition under conditions which encourage the antimicrobial composition to permeate the material of the medical implant. Darouiche claims that an alkalinizing agent such as sodium hydroxide enhances the reactivity of the substrate. The penetrating agent, ethyl acetate, promotes penetration of the antimicrobial agent into the material of the medical device. This method of impregnation showed extended efficacy profiles due to the large amount of antimicrobial substance that was added to the substrate.

Potential problems associated with impregnating a polymer by way of swelling it with a solvent include: a) changes in physical properties of a polymer due to the presence of a bioactive compound within its matrix, b) polymer degradation and weakening from solvent and/or heat exposure, and c) changes in physical properties of a polymer due to swelling and de-swelling activities. Frequently, subjecting an elastomeric polymer to an organic solvent can have the effect of weakening or even dissolving the elastomer.

The use of antimicrobial agents that result in slow release of the silver (I) ion is widespread in medical applications. A typical antimicrobial agent is silver sulfadiazine, which is widely used in burn wound applications. The rate of release of silver from silver sulfadiazine occupies a middle ground between that observed for silver nitrate and the very slow rate of release observed with, for example, silver sulfathiazole. Indwelling medical devices coated with polymers containing antimicrobial agents require some degree of extended release to protect the device against microbial colonization, if the goal is to achieve protection of the device from microorganisms for more than a few hours. Silver sulfadiazine is known to exhibit such extended release and is used in currently marketed devices.

Interest in using silver and silver compounds in combination with polymeric materials in order to prevent or reduce microbial colonization on the surface of such materials has increased over the past several decades. The most common forms of silver combined with a polymer are micronized silver metal, silver salts, silver oxides and chelated silver compounds. A common approach used in applying silver to a polymer has been to use silver as or in a coating on the surface of the polymer. An example of this is a hydrophilic coating containing one of the various forms of silver. These coating technologies typically employ micronized silver or highly insoluble silver compounds in order to slow silver ion elution. Impregnation technologies also make use of sparingly soluble or slightly soluble silver salts, such as silver chloride, which feature highly controllable precipitation behavior. Chemical reduction of silver ions to particles of silver metal, using for example sodium citrate, has also been used for coating and impregnation processes. Another relevant technology is adding silver or silver compounds to the pre-polymer mixture before it is molded or extruded. There are advantages and disadvantages to each method including antimicrobial effectiveness, cost of manufacture, color changes, and potential changes in the physical properties of the resulting polymer. Obtaining effective elution profiles via impregnation of polymers with oligodynamic metals, such as silver compounds, using solvents for impregnation, or using silver as a component of the pre-polymer mixture, has proven to be more difficult than expected. Silver ions contained in coatings tend to elute rapidly, while silver ions entrapped within extruded or molded articles can be retained to a pronounced degree within the article.

A report by Illner, H. et al. (Illner, H., Hsia, W. C., Rikert, S. L., Tran, R. M., and Straus, D. (1989) Use of topical antiseptic in prophylaxis of catheter-related septic complications. Surg Gynecol Obstet 168, 481-490) describes impregnation of silicone rubber catheters and a polyethylene catheter using a 95% ethanol/5% water solution saturated with silver nitrate. In order to maximize antimicrobial properties, the silicone catheters were soaked for between one and six weeks, and the study of polyethylene was cut short due to its poor in vitro efficacy. After soaking the treated silicone in phosphate buffered saline (PBS) for 6 weeks the articles were transferred to agar plates for zone of inhibition (ZOI) experiments. The experiments resulted in unimpressive inhibition results. Illner obtained a patent (U.S. Pat. No. 5,709,672) that describes the use of a combination of gentian violet and silver nitrate impregnated into silicone rubber and polyurethane.

As is implied by mention of the various silver compounds above, there are many counter-ions that can be paired with silver (I). A subset of these counter-ions will exhibit release rates that are desirable in various medical applications. One example of a less obvious counter-ion is the carbon-carbon double bond, which is known to form a complex with silver (I). The nature of this bonding takes place through formation of a σ-bond between the olefin and silver, which results from olefin π-donation to the vacant 5s orbital of silver atoms. This is accompanied by back-donation from the occupied 4d orbital of silver to the unfilled π*-2p anti-bonding orbital of the olefin. The formation of this bond is typically reversible, a feature that can be exploited in device applications. For example, silver can potentially be bound to an olefin (contained in or on a device) under solvated conditions. Following removal of the solvent, the now olefin-bound silver ion remains available as an antimicrobial agent on the surface of and, depending on the conditions used, within the device. Upon hydration under conditions of use, the silver ions can be released from the olefin moiety and are then free to exhibit antimicrobial effectiveness. The olefinic bonds contained in polyisoprene polymers are shown herein to bind silver ions upon exposure of the polyisoprene to a swelling solvent containing silver nitrate. In addition, silver is released slowly upon exposure to aqueous conditions to provide extended antimicrobial effectiveness under such conditions to articles treated with the subject process.

No prior art methods for combining a silver salt with an elastomer has shown to provide such a high rate of silver incorporation or as high a total silver quantity (based on percent weight) as the invention presented herein. Prior silver salt impregnation techniques incorporated silver salts into polymers slowly and with fairly low loads of silver salt. For example, adding an elastomer to a mixture containing chloroform and silver nitrate yields no silver incorporation into the elastomer (even after days of soaking). Adding an elastomer to a mixture containing methanol or ethanol and silver nitrate yields very little silver incorporation into the elastomer (after many hours of soaking). The examples shown in Illner (mentioned above) using solvents in which silver salts are only slightly soluble took 1 to 6 weeks. Experiments have demonstrated that chloroform, in which silver nitrate is insoluble, does not impregnate silver salts into polymers. A surprising result occurs when chloroform is combined with methanol or ethanol: the rate of silver incorporation is dramatically increased for certain ratios of chloroform and alcohols. Unexpectedly, a significantly faster rate of incorporation and considerably higher quantities of silver nitrate impregnation can be achieved through the use of solvents in which silver nitrate is highly insoluble. This process is distinguished from those found in the prior art by the unique combination of solvents and their effect on the impregnation rate. In addition to the increased rate of incorporation, the resulting silver (I) ion elution profile is extended, due to the increased quantity of silver loaded in the article and by the release rate afforded by polyisoprene, due to its interaction with silver. Impregnating a polymeric material with a soluble form of ionic silver and obtaining an extended elution profile has proven to be difficult.

Unless otherwise defined, the technical, scientific, and medical terminology used herein has the same meaning as understood by those skilled in the art. However, for the purposes of establishing support for various terms that are used in the present application, the following technical definitions are provided for reference.

The term “excess” as used herein refers to a quantity resulting in a saturated, half-saturated, or supersaturated solution.

The term “swellable” as used herein refers to a polymeric article that increases in size when exposed to a solvent.

The present invention provides a polymer incorporated with a broad spectrum antimicrobial bioactive metal and a method of making such a polymer. The produced polymer exhibits extended elution of bioactive metals. Examples of suitable bioactive metals include but are not limited to sources of silver (I) ions, copper (II) ions, zinc ions and other metal ions. According to the present invention, the polymer is impregnated with a bioactive metal using a combination of solvents. The quantity of bioactive metal incorporated within the polymer is substantially increased for a given impregnating time period (i.e. reaction time) when compared to the prior art. Complementing this significant processing rate increase, the incorporated bioactive metal elutes as an ionic metal (e.g., ionic silver), a broad spectrum antimicrobial, when the treated polymer is subjected to aqueous conditions. The bioactive metal elution occurs at a rate that is effective in preventing microbial growth for up to 6 weeks or even longer. In one embodiment, the bioactive metal is a source of silver (I) ions. Examples of suitable silver salts that provide a source of silver (I) ions include but are not limited to silver nitrate, silver sulfadiazine, silver sulfathiazole and silver chloride.

In one embodiment, the bioactive metal is insoluble in a first solvent or solvent mixture. The bioactive metal is slightly soluble in a second solvent or solvent mixture. The first and second solvents are combined with the bioactive metal to form a bioactive metal solution. The bioactive metal solution can be a saturated solution, a supersaturated solution or an unsaturated solution with respect to the amount and condition of the bioactive metal present in the solution. Once the bioactive metal solution has been prepared, a polymer is soaked in the bioactive metal solution so that the bioactive metal becomes impregnated in and on the polymer.

In an exemplary embodiment the bioactive metal is a silver salt as described above. Examples of solvents in which silver nitrate, one particular silver salt, is insoluble include but are not limited to: aromatic hydrocarbons (e.g., xylene), chlorinated hydrocarbons (e.g., chloroform), esters/acetates (e.g., ethyl acetate), aliphatic hydrocarbons (e.g., hexane), cycloalkanes (e.g., cyclohexane), and any combinations thereof. In exemplary embodiments, non-polar organic solvents are preferred; however, slightly polar solvents that are capable of swelling elastomers are also candidates for use in the present invention. These slightly polar solvents include but are not limited to: alcohols (e.g., hexanol), nitriles (e.g., acetonitrile), ketones (e.g., acetone), amines (e.g., isopropylamine), heterocyclic solvents (e.g., tetrahydrofuran), ethers (e.g., diethyl ether), and any combinations thereof. Additionally, other additives can also be added to the above solvents to alter solubility or impregnation rates.

The solvents in which silver nitrate is slightly soluble include a range of polar or slightly polar solvents that are also miscible in the non-polar organic solvents. Examples include but are not limited to: alcohols (e.g., ethanol), nitriles (e.g., acetonitrile), ketones (e.g., acetone), amines (e.g., isopropylamine), heterocyclic solvents (e.g., tetrahydrofuran), multifunctional solvents (e.g. triethanolamine), ethers (e.g., diethyl ether) and any combinations thereof. Additionally, other additives can also be added to the above solvents to alter solubility or impregnation rates.

Suitable polymers for being impregnated by the bioactive metal include polyisoprene and other elastomeric polymers. In contrast to polymers used previously, such as silicone, polyisoprene has been discovered to have superior properties with respect to impregnation and release of silver. Polyisoprene impregnated with silver nitrate using the mixture of solvents described herein imparts silver ion elution profile not disclosed in the prior art. Additionally, the rate of impregnation of polyisoprene with silver nitrate is a differentially rapid process under the disclosed conditions, providing a very efficient manufacturing process.

In addition to superior uptake and elution of silver nitrate, polyisoprene features superior resistance to degradation in swelling solvents relative to other elastomers. During experiments performed on a number of different elastomeric polymers, it was observed that peroxide-cured polyisoprene significantly resisted disintegration and other physical property changes after removal from the swelling solvents followed by drying. Silicone, polydimethylsiloxane (PDMS), and natural rubber latex elastomers disintegrated within 24 hours of soaking, whereas peroxide-cured polyisoprene could be soaked in the same solvents for weeks without disintegration or, once dried, any pronounced physical changes.

Suitable levels of bioactive metal impregnation can vary depending on the article being coated, the particular bioactive metal selected and other factors. The present invention provides for impregnating polymers so that they contain between about 0.10% bioactive metal and about 15% bioactive metal by weight. In order to reach those levels, the polymer is soaked in the bioactive metal solution for a time between about 30 seconds and about 48 hours. In exemplary embodiments, targeted impregnation is achieved between about 10 minutes and about 24 hours. In other exemplary embodiments, targeted impregnation is achieved in about 3 hours or less. These time frames are significantly faster than what has been described in the prior art (e.g., Illner describes a soaking time of 1 to 6 weeks).

In exemplary embodiments, polyisoprene (or other elastomeric polymer) is soaked in a swelling agent such as chloroform or chloroform/alcohol or butyl acetate or any combinations thereof (however any solvent that will swell elastomeric polymers may be used) that contains silver nitrate at temperatures between about −10° C. and about 100° C. for between about 30 seconds and about 48 hours. The temperature and soaking time selected will depend, in part, on the desired loading of silver nitrate in and/or on the elastomeric polymer.

A significantly faster rate of incorporation and considerably higher quantities of bioactive metal impregnation are achieved relative to the exclusive use of solvents in which the bioactive metal is highly soluble. This process is distinguished from those found in the prior art by the unique combination of solvents and their effect on the impregnation rate. The resulting elution rate is extended as well, both by the greater quantity of silver loaded in the polymer as a result of the use of this method and by the release rate afforded by the impregnated polymer, due to its interaction with silver.

In an additional exemplary embodiment, a bioactive metal-impregnated polymer contains additional antimicrobial agents or other bioactive compounds. Examples of antimicrobial agents include, but are not limited to, rifampin, clindamycin, minocycline, chlorhexidine, sulfadiazine, erythromycin, norfloxacin, tobramycin, miconazole, quarternary ammonium salts and other antimicrobials. The antimicrobial agents or bioactive(s) may be impregnated during the silver nitrate soaking step or a separate soaking step. The separate soaking step may occur before or after the silver nitrate soaking step.

Included in this invention are methods of impregnating a polymer with antimicrobial agents or other bioactives by soaking the polymer in swelling solvents for a period of time and at temperatures that are known to disintegrate other types of elastomers commonly used for making medical devices. Another embodiment includes the use of an elastomeric polymer that is capable of being swelled in a solvent or combination of solvents.

In another embodiment of the present invention, a polymer (polyisoprene or another elastomeric polymer) is first soaked in a swelling solvent or agent for between about 5 and about 1 hour between about 20° C. and about 100° C. The polymer is then removed from the swelling solvent and soaked in a solution containing a bioactive metal and a solvent in which the bioactive metal is slightly soluble. The polymers, bioactive metals, solvents and additional antimicrobial agents described above can also be used in this embodiment. Additionally, the solvent used in the bioactive metal solution can be the same solvent used as the swelling agent in the first step.

In another embodiment of the present invention, a bioactive metal solution may be prepared having a bioactive material and a solvent mixture in which the bioactive metal is slightly soluble. A polymer may be soaked in the bioactive metal solution for between about 10 minutes and about 3 hours. The polymers, bioactive metals, and additional antimicrobial agents described above may be used in this embodiment. Suitable solvent mixtures may include ethyl acetate, butyl acetate, alcohols and combinations thereof.

### EXAMPLES

### Example 1

Excess silver nitrate was added to a solvent mixture containing 77% chloroform, 22% absolute ethanol, and 1% de-ionized water (DI water) by volume. The vessel was sealed and the mixture stirred at 48° C. for 10 minutes. Polyisoprene articles were then submerged in the solution for 45 minutes with stirring, at which time the articles were removed and rinsed several times with a mixture of 95% alcohol (ethanol or isopropyl alcohol) and 5% water. The remaining solvents were removed from the swelled polyisoprene articles by heating, evacuation, or a combination of both. Evacuation refers to removal of most or all residual solvents from treated articles via vacuum. In all cases the heat was kept below 80° C. to preserve the physical properties of the polyisoprene articles.

Polyisoprene articles weighing approximately 58 milligrams (mg) were impregnated with silver nitrate using the method described above. All articles were sterilized using either gamma irradiation or ethylene oxide and then subjected to zone of inhibition (ZOI) experiments. The treated articles were challenged with the following organisms, a selection of gram-positive and gram-negative species, as well as one yeast (all were clinical isolates): S. aureus, C. albicans, P. aeruginosa, K. pneumoniae, E. faecalis, E. coli, and S. epidermidis. The treated articles were transferred to freshly inoculated Mueller Hinton agar plates a total of 7 times over the course of 9 days. Presented in Table 1 are the results from the plate to plate ZOI studies (7 days) for silver nitrate-treated polyisoprene. The diameter of each zone was measured in millimeters (mm), and the polyisoprene articles were accompanied by positive and negative controls (not shown).

TABLE 1

| | |
|---|---|
| ETO | Gamma |

| | | | | |
|---|---|---|---|---|
| Day | A (mm) | B (mm) | A (mm) | B (mm) |

a) E. coli

| | | | | |
|---|---|---|---|---|
| 1 | 11.27 | 11.28 | 12.86 | 12.86 |
| 2 | 11.9 | 11.16 | 11.96 | 12.11 |
| 3 | 11.06 | 8.74 | 9.19 | 8.75 |
| 4 | 10.87 | 9.1 | 9.18 | 7.88 |
| 5 | 12.32 | 10.52 | 7.85 | 8.14 |
| 6 | 6.51 | 8.39 | 6.58 | 6.1 |
| 7 | 7.99 | 8.33 | 6.72 | 6.1 |

b) E. faecalis

| | | | | |
|---|---|---|---|---|
| 1 | 13.95 | 12.97 | 14.79 | 14.05 |
| 2 | 17.63 | 15.17 | 15.75 | 16.18 |
| 3 | 9.91 | 10.97 | 10.33 | 9.68 |
| 4 | 9 | 9.65 | 9 | 8.84 |
| 5 | 8.41 | 7.78 | 8.05 | 8.51 |
| 6 | 8.43 | 8.42 | 8.1 | 8.33 |
| 7 | 8.61 | 8.65 | 9.23 | 8.19 |

c) K. pneumoniae

| | | | | |
|---|---|---|---|---|
| 1 | 7.32 | 7.85 | 8.24 | 9.14 |
| 2 | 12.67 | 14.87 | 13.59 | 13.31 |
| 3 | 9.65 | 7.8 | 9.53 | 7.75 |
| 4 | 6.38 | 8.67 | 6.9 | 6.47 |
| 5 | 12.08 | 8.92 | 9.59 | 7.86 |
| 6 | 6.72 | 6.55 | 6.28 | 5.58 |
| 7 | 7.28 | 6.49 | 10.49 | 5.79 |

d) P. aeruginosa

| | | | | |
|---|---|---|---|---|
| 1 | 15.53 | 15.86 | 14.75 | 15.79 |
| 2 | 18.74 | 18.32 | 18.48 | 20.01 |
| 3 | 13.99 | 15.99 | 14.91 | 14.7 |
| 4 | 13.59 | 11.86 | 11.69 | 11.73 |
| 5 | 12.36 | 12.06 | 11.49 | 11.05 |
| 6 | 13.16 | 11.34 | 10.63 | 11.42 |
| 7 | 14.24 | 11.76 | 12.08 | 12.9 |

e) C. albicans

| | | | | |
|---|---|---|---|---|
| 1 | 20.08 | 20.31 | 23.23 | 22.75 |
| 2 | 19.6 | 21.75 | 22.09 | 21.12 |
| 3 | 15.75 | 15.57 | 13.97 | 14.39 |
| 4 | 13.9 | 13.14 | 10.55 | 11.07 |
| 5 | 12.81 | 12.21 | 14.2 | 12.71 |
| 6 | 10.12 | 10.88 | 12.82 | 12.8 |
| 7 | 14.29 | 13.48 | 12.23 | 12.21 |

f) S. aureus

| | | | | |
|---|---|---|---|---|
| 1 | 11.93 | 11.6 | 13.22 | 11.88 |
| 2 | 14.5 | 15.02 | 15.6 | 12.96 |
| 3 | 8.71 | 9 | 8.91 | 9.31 |
| 4 | 8.43 | 8.62 | 7.51 | 7.79 |
| 5 | 8.03 | 9 | 8.49 | 8.23 |
| 6 | 7.61 | 7.93 | 7.08 | 7.22 |
| 7 | 8.01 | 8.03 | 7.68 | 7.25 |

g) S. epidermis

| | |
|---|---|
| 1 | No Growth |

| | | | | |
|---|---|---|---|---|
| 2 | 16.03 | 15.33 | 15.39 | 16.15 |
| 3 | 12.29 | 13.28 | 11.03 | 11.57 |
| 4 | 11.45 | 11.74 | 10.16 | 9.26 |
| 5 | 15.23 | 14.3 | 14.32 | 12.67 |
| 6 | 9.89 | 9.58 | 9.37 | 9.93 |
| 7 | 9.44 | 10.15 | 9.46 | 9.66 |

Table 1 (a-g) shows zone of inhibition (ZOI) results for both gamma and ethylene oxide sterilized polyisoprene articles impregnated with silver nitrate using the method of Example 1. Samples were submitted in duplicate for each sterilization process. Agar plates were inoculated with the following organisms: E. coli, E. faecalis, K. pneumoniae, P. aeruginosa, C. albicans, S. aureus, and S. epidermidis. They were then incubated for 12-18 hours at approximately 34° C. to allow for organism growth and visualization. The diameter of each zone is reported in millimeters. The test articles were accompanied in each plate with both positive and negative control articles, resulting in the expected inhibition for the positive control (10 μg gentamicin disk) and growth up to the article for the negative control (untreated polyisoprene article). The control results are not shown.

### Example 2

### Extended Antimicrobial Efficacy

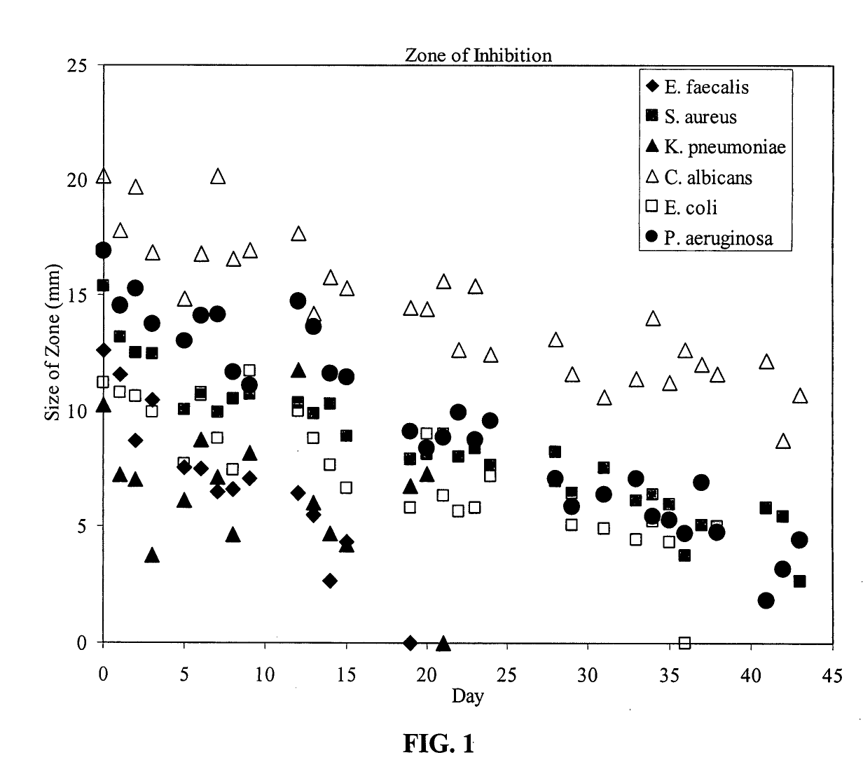

Polyisoprene articles were impregnated with silver nitrate using a modified version of the method used in Example 1, the only difference being the soaking time for the polyisoprene articles was 1.5 hours instead of 45 minutes. These articles were also sterilized by either gamma irradiation or exposure to ethylene oxide and then subjected to zone of inhibition (ZOI) experiments. The treated parts were challenged by the following organisms, a selection of gram-positive and gram-negative species, as well as one yeast (all were clinical isolates): S. aureus, C. albicans, P. aeruginosa, K. pneumoniae, E. faecalis, and E. coli, and S. epidermidis. The parts were transferred to freshly inoculated Mueller Hinton agar plates a total of 31 times over the course of 43 days. The data is summarized in FIG. 1.

FIG. 1 shows the results of a plate to plate zone of inhibition experiment, in which inoculation and incubation were performed as described above, and the article was removed from the agar plate and placed into a freshly inoculated plate each day (for days on which no such transfer occurred, the articles were left in place until transfer). The articles were transferred a total of 31 times over a period of 43 days. The diameter of each zone is reported in millimeters.

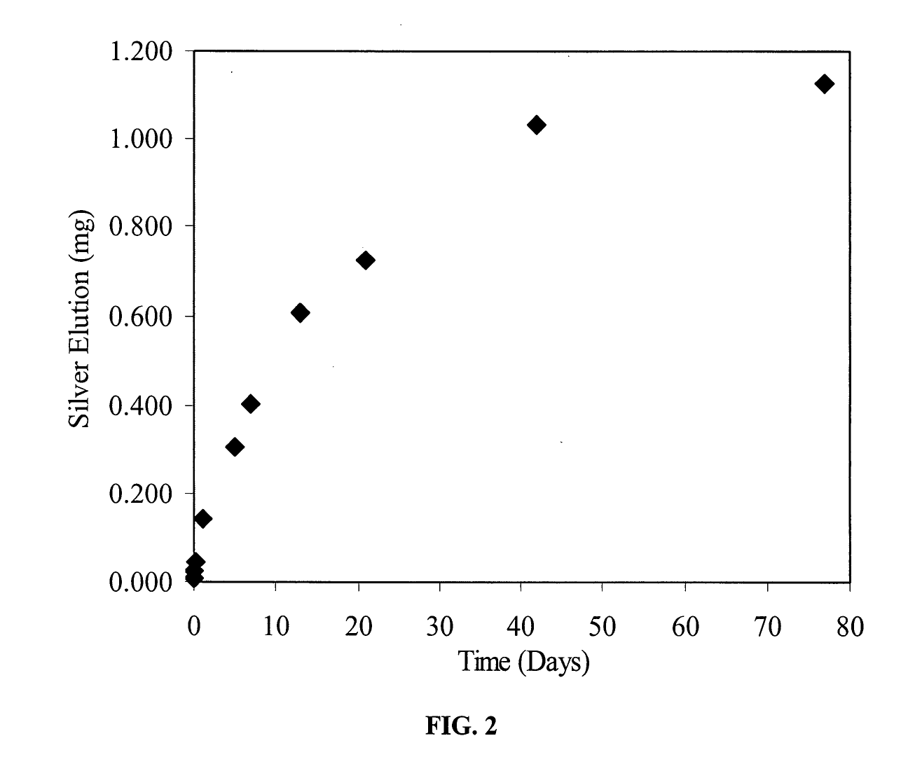

FIG. 2 shows cumulative silver ion elution in DI water at 22° C. A polyisoprene article prepared as described in Example 2 was agitated in 35 mL DI water for 77 days. At the indicated time points a small aliquot was removed for silver measurement using atomic absorption spectroscopy.

### Example 3

### Comparison of Subject Process to Those Appearing in the Prior Art

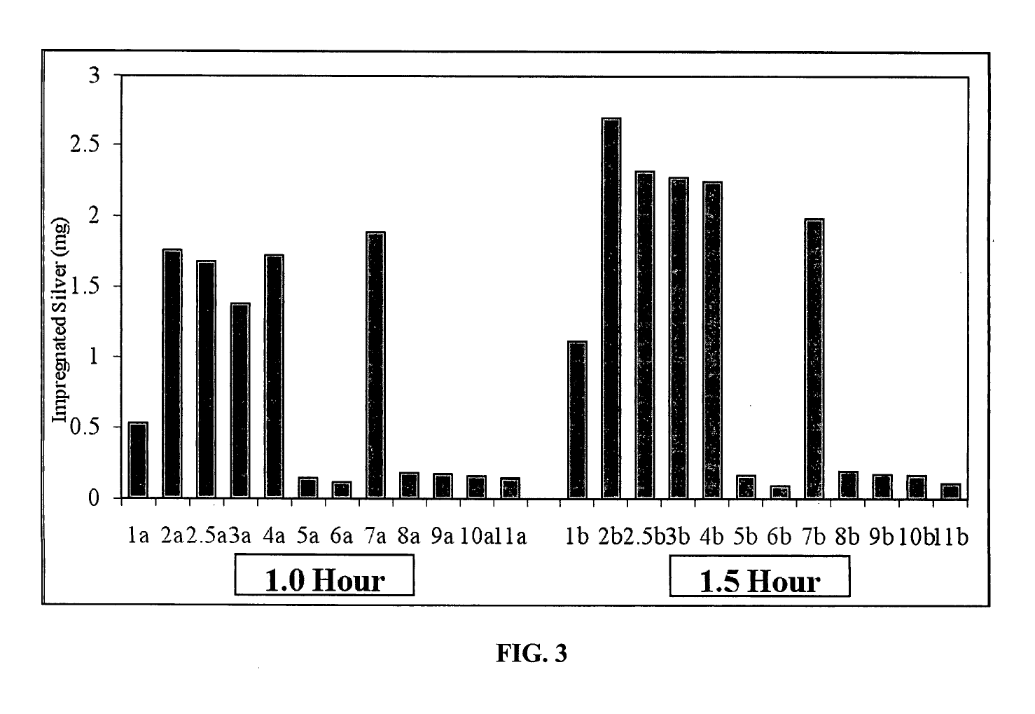

Silver nitrate was impregnated into polyisoprene articles weighing approximately 58 mg each using a saturated solution of silver nitrate at 48° C. for 1 hour (A) and 1.5 hour (B). The various solvent compositions are shown in Table 2 and the resulting total silver loads are shown in FIG. 3.

TABLE 2

| Sample | Chloroform | Methanol | Ethanol | Isopropyl | Water |
|---|---|---|---|---|---|
| 1 | 77 | 23 | | | |
| 2 | 77 | | 22 | | 1 |
| 2.5 | 77 | | 22 | | 1 |
| 3 | 77 | 22 | | | 1 |
| 4 | 77 | | | 22 | 1 |
| 5 | 95 | | 4 | | 1 |
| 6 | | | 95 | | 5 |
| 7 | 34 | | 65 | | 1 |
| 8 | 10 | | 89 | | 1 |
| 9 | 5 | | 94 | | 1 |
| 10 | 1 | | 98 | | 1 |
| 11 | | | 95 | | 5 |

Table 2 shows various solvent compositions used for impregnating polyisoprene with silver nitrate by relative volume. These compositions are presented here for the purpose of comparing the methods of the present invention to those appearing in the prior art. The superiority of the subject process relative to previous processes is evident in FIG. 3, which follows. FIG. 3 represents the total quantity of silver (in milligrams) impregnated into approximately 58 milligrams of polyisoprene using saturated solutions of silver nitrate at 48° C. for 1 hour (a) and 1.5 hour (b). Samples 1 through 11 represent the various solvent compositions shown in Table 2. Samples 6 and 11 represent those appearing in the prior art, and serve to illustrate the superiority of the subject process. These compositions also demonstrate that various alcohols can be used without severe alteration to the result. The results of these experiments show distinct differences among the various solvent mixtures used.

### Example 4

Excess silver nitrate was added to a solvent mixture containing 77% chloroform and 23% absolute ethanol by volume. The vessel was sealed and the mixture stirred at 48° C. for 10 minutes. The polyisoprene articles were submerged in the solution for 45 minutes with stirring, at which time the articles were removed and rinsed several times with a mixture of 95% alcohol (ethanol or isopropyl alcohol) and 5% water. The remaining solvents were removed from the swelled polyisoprene articles by heating, evacuation, or a combination of both. In all cases the heat was kept below 80° C. to preserve the physical properties of the polyisoprene articles.

Although these examples provide specific means of producing polyisoprene articles impregnated with silver nitrate they are not intended to represent the only methods for achieving this goal. The experimental parameters, such as the solvent ratios and the time of article soaking, may be modified depending on the desired physical and antimicrobial properties of the article.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A method for impregnating a polymer with a bioactive metal at a concentration between about 0.10% and about 15% by weight, the method comprising:
preparing a bioactive metal solution comprising:
a bioactive metal;
a first solvent in which the bioactive metal is insoluble; and
a second solvent in which the bioactive metal is slightly soluble; and
soaking the polymer in the bioactive metal solution.

2. The method of claim 1, wherein the bioactive metal is a source of silver (I) ions.

3. The method of claim 2, wherein the bioactive metal is selected from the group consisting of silver nitrate, silver sulfadiazine, silver sulfathiazole, silver chloride and combinations thereof.

4. The method of claim 1, wherein the polymer is polyisoprene.

5. The method of claim 1, wherein the bioactive metal solution contains between about 0.005 and about 0.5 grams of bioactive metal for every 1 gram of polymer.

6. The method of claim 5, wherein the polymer is impregnated with a targeted amount of the bioactive metal after the polymer is soaked in the bioactive metal solution for between about 10 minutes and about 3 hours.

7. The method of claim 1, further comprising:
soaking the polymer in an antimicrobial solution.

8. The method of claim 7, wherein a component of the antimicrobial solution is selected from the group consisting of rifampin, clindamycin, minocycline, chlorhexidine, sulfadiazine, erythromycin, norfloxacin, tobramycin, miconazole, quaternary ammonium salts and combinations thereof.

9. The method of claim 7, wherein the polymer is soaked in the bioactive metal solution and the antimicrobial solution at the same time.

10. A method for rapidly impregnating a polymer with between about 0.10% and about 15% of a bioactive metal by weight, the method comprising:
preparing a bioactive metal solution comprising:
the bioactive metal;
a solvent mixture in which the bioactive metal is slightly soluble; and
soaking the polymer in the bioactive metal solution, for between about 10 minutes and about 3 hours.

11. A method for rapidly impregnating a polymer with between about 0.10% and about 15% of a bioactive metal by weight, the method comprising:
soaking the polymer in a swelling solvent for between about 5 minutes and about 1 hour;
soaking the polymer in a bioactive metal solution comprising:
the bioactive metal; and
a solvent in which the bioactive metal is slightly soluble.

12. The method of claim 11 wherein the polymer is polyisoprene and wherein the bioactive metal is selected from the group consisting of silver nitrate, silver sulfadiazine, silver sulfathiazole, silver chloride and combinations thereof.

13. The method of claim 11, wherein the solvent of the bioactive metal solution is the same as the swelling solvent.

14. The method of claim 11, further comprising soaking the swellable polymer in an antimicrobial solution containing a component selected from the group consisting of rifampin, clindamycin, minocycline, chlorhexidine, sulfadiazine, erythromycin, norfloxacin, tobramycin, miconazole, quaternary ammonium salts and combinations thereof.

15. The method of claim 14, wherein the swellable polymer is soaked in the saturated silver salt solution and the antimicrobial solution at the same time.

16. A bioactive metal-impregnated polymer, wherein a polymer is soaked in a saturated bioactive metal solution comprising a bioactive metal, a swelling solvent in which the bioactive metal is insoluble, and a second solvent in which the bioactive metal is slightly soluble.

17. The bioactive metal-impregnated polymer of claim 16, wherein the bioactive metal is selected from the group consisting of silver nitrate, silver sulfadiazine, silver sulfathiazole, silver chloride and combinations thereof.

18. The bioactive metal-impregnated polymer of claim 16, wherein the polymer is polyisoprene.

19. The bioactive metal-impregnated polymer of claim 16, wherein the bioactive metal solution contains between about 0.005 and about 0.5 grams of bioactive metal for every 1 gram of polymer.

20. The bioactive metal-impregnated polymer of claim 16, further comprising:
an antimicrobial agent selected from the group consisting of rifampin, clindamycin, minocycline, chlorhexidine, sulfadiazine, erythromycin, norfloxacin, tobramycin, miconazole, quaternary ammonium salts and combinations thereof.
